(19) United States
(12) Patent Application Publication
(10) Pub. No.: US 2024/0125693 A1
(43) Pub. Date: Apr. 18, 2024

(54) BIOSENSING SYSTEM AND SENSING DEVICE THEREOF

(71) Applicant: MING CHUAN UNIVERSITY, Taipei (TW)

(72) Inventor: Yu-Cheng LIN, Taipei (TW)

(21) Appl. No.: 17/967,833

(22) Filed: Oct. 17, 2022

(51) Int. Cl. G01N 21/25; G01N 21/552; G02B 5/00; G02B 6/122; G02B 6/26

(52) U.S. Cl. CPC G01N 21/255; G01N 21/553; G02B 5/008; G02B 6/1226; G02B 6/26; G01N 2021/258

(57) ABSTRACT

A sensing device includes an optical waveguide substrate and a plurality of biological probes. The optical waveguide substrate includes a light input end and a light output end. A plurality of biological probes are arranged and aligned on the optical waveguide substrate along a direction from the light input end to the light output end. The plurality of biological probes respond to different resonance wavelengths along the direction corresponding to different analytes. The present disclosure further includes a biosensing system including the sensing device.

### BACKGROUND

### Technical Field

The present disclosure relates to a biosensing system and a sensing device thereof, in particular to a biosensing system and a sensing device thereof capable of performing multiplex detection on multiple resonant wavelengths.

### Description of Related Art

In the diabetes detection, a blood sugar status in the past three months is generally judged by measuring a glycosylated hemoglobin (HbA1c). Surface plasmon resonance (SPR) technology is widely used in biological and chemical fields for molecular-level detection due to its high sensitivity. In many research works on SPR, it is generally constructed by using a high refractive index prism, and an incident angle of light may be changed in a wide-angle range, all changes of any medium and an analyte may have a suitable angle to excite a surface plasmon, so that an incident light may occur total internal reflection (TIR) at an interface between an optical waveguide and a resonant film, and an evanescent wave may be generated. When interpreting light in terms of electromagnetic wave theory, the incident light includes transverse electronic (TE) waves and transverse magnetic (TM) waves, and the SPR technology is only being excited by TM waves.

However, the sensor structure with a prism design usually has a huge volume, requires expensive optical equipment (such as a lens group) and precision mechanical equipment (such as an air-cushion optical shockproof equipment), requires complicated light-aligning mechanism, and it is not easy to achieve miniaturization and mass production. In addition, the related-art technology requires different unique biological probes for different substances, and sensors adapted to the plurality of biological probes. Since each substance is corresponding to each biological probe, the sensor may only detect single signal. Therefore, when an analyte is mixed with multiple substances or its contents are unknown, that increases the difficulty and convenience of detection.

Therefore, how to design a biosensing system and a sensing device thereof to solve the aforementioned technical problems is an important subject studied by the inventor of the present disclosure.

### SUMMARY

One object of the present disclosure is to provide a sensing device, which avoids using a prism with a huge volume, and performs multiplex detection on multiple resonance wavelengths. Therefore, the technical problems in the related art of miniaturization and reducing the difficulty of detection being difficult to be realized are solved, and the purposes of convenient carrying, easy mass-production and convenient detection are achieved.

In order to achieve the object of the present disclosure, the sensing device includes an optical waveguide substrate and a plurality of biological probes. The optical waveguide substrate includes a light input end and a light output end. The plurality of biological probes are arranged and aligned on the optical waveguide substrate along a direction from the light input end to the light output end. The plurality of biological probes respond different resonance wavelengths along the direction corresponding to different analytes.

In some embodiments, the optical waveguide substrate includes a transverse magnetic (TM) resonance region and a transverse electric (TE) resonance region free from overlapping with each other, the TM resonance region is adjacent to the light input end, and the TE resonance region is adjacent to the light output end. A surface plasmon resonance (SPR) sensing region resonates to a TM wave first, leaving a TE wave to a lossy mode resonance (LMR) sensing region behind.

In some embodiments, the plurality of biological probes include a first probe and a second probe. The first probe is arranged in the TM resonance region and adjacent to the light input end. The second probe is arranged in the TM resonance region and adjacent to the TE resonance region. Further, a resonance wavelength is responded by the first probe is different from a resonance wavelength is responded by the second probe.

In some embodiments, the TM resonance region includes a surface plasmon resonance (SPR) layer, and the first probe and the second probe are arranged on the SPR layer.

In some embodiments, the plurality of biological probes include a third probe and a fourth probe. The third probe is arranged in the TE resonance region and adjacent to the TM resonance region. The fourth probe is arranged in the TE resonance region and adjacent to the light output end. Further, a resonance wavelength is responded by the third probe is different from a resonance wavelength is responded by the fourth probe.

In some embodiments, the TE resonance region includes a lossy mode resonance (LMR) layer, and the third probe and the fourth probe are arranged on the LMR layer.

In some embodiments, a material of the optical waveguide substrate is one of a glass material, a quartz material or a polymer material.

Another object of the present disclosure is to provide a biosensing system, which avoids using a prism with a huge volume, and performs multiplex detection on multiple resonance wavelengths. Therefore, the technical problems in the related art of miniaturization and reducing the difficulty of detection being difficult to be realized are solved, and the purposes of convenient carrying, easy mass-production and convenient detection are achieved.

In order to achieve the object of the present disclosure, the biosensing system includes a light source, a sensing device as in any of the preceding embodiments, and a spectrometer. The light source outputs a first light. The sensing device receives the first light and outputs a second light. The spectrometer is connected to the sensing device and receives the second light.

In some embodiments, the spectrometer simultaneously detects a plurality of sensing regions on the sensing device responding to different resonance wavelengths.

In some embodiments, the light source includes a halogen lamp.

Therefore, the sensing device of the present disclosure is structured by arranging and aligning the plurality of biological probes on the optical waveguide substrate. Comparing with the related art, expensive and complicated optical equipment such as bulky lens groups and air-cushion optical shockproof equipment are not required in the disclosure. In addition, the optical path set in a form of planar waveguide does not need a complicated light alignment mechanism, and it is easy to achieve miniaturization and mass production.

It is worth mentioning that, the plurality of biological probes are arranged and aligned along the direction from the light input end to the light output end according to different responding resonance wavelengths. Therefore, when the plurality of biological probes are corresponding to different analytes simultaneously, the plurality of biological probes respond different resonance wavelengths simultaneously along the direction. Especially for an analyte that is mixed with multiple unknown substances, or the resonance wavelengths change over time (for example, biomolecules, etc.), the present disclosure may avoid missing any substance to be tested due to setting a wrong single resonant wavelength, so that the analyte is label free and tedious steps in whole experimental process are avoided.

Therefore, the biosensing system and the sensing device of the present disclosure avoid using a prism with a huge volume, and performs multiplex detection on multiple resonance wavelengths. Therefore, the technical problems in the related art of miniaturization and reducing the difficulty of detection being difficult to be realized are solved, and the purposes of convenient carrying, easy mass-production and convenient detection are achieved.

In order to further understand the techniques, means, and effects of the present disclosure for achieving the intended object. Please refer to the following detailed description and drawings of the present disclosure. The drawings are provided for reference and description only, and are not intended to limit the present disclosure.

### BRIEF DESCRIPTION OF DRAWINGS

FIG. 1 is an external view of a first embodiment of a sensing device of the present disclosure.

FIG. 2 is a structural diagram of biological probes of the sensing device of the present disclosure.

FIG. 3 is a spectrogram view of a signal strength sensed by the sensing device of the present disclosure.

FIG. 4 is an external view of a second embodiment of the sensing device of the present disclosure.

FIG. 5 is a schematic diagram of a configuration of a biosensing system of the present disclosure.

### DETAILED DESCRIPTION

The following are specific examples to illustrate some implementations of the present disclosure. A person skilled in the art may understand the advantages and effects of the present disclosure from the content disclosed in this specification. The present disclosure may be implemented or applied through other different specific embodiments, and various details in this specification may also be based on different viewpoints and applications, and various modifications and changes may be made without departing from the concept of the present disclosure.

It should be understood that the structures, the proportions, the sizes, the number of components, and the like in the drawings are only used to cope with the contents disclosed in the specification for understanding and reading by those skilled in the art, and it is not intended to limit the conditions that may be implemented in the present disclosure, and thus is not technically significant. Any modification of the structure, the change of the proportional relationship, or the adjustment of the size, should be within the scope of the technical contents disclosed by the present disclosure without affecting the effects and the achievable effects of the present disclosure.

The technical content and detailed description of the present disclosure are described below with the drawings.

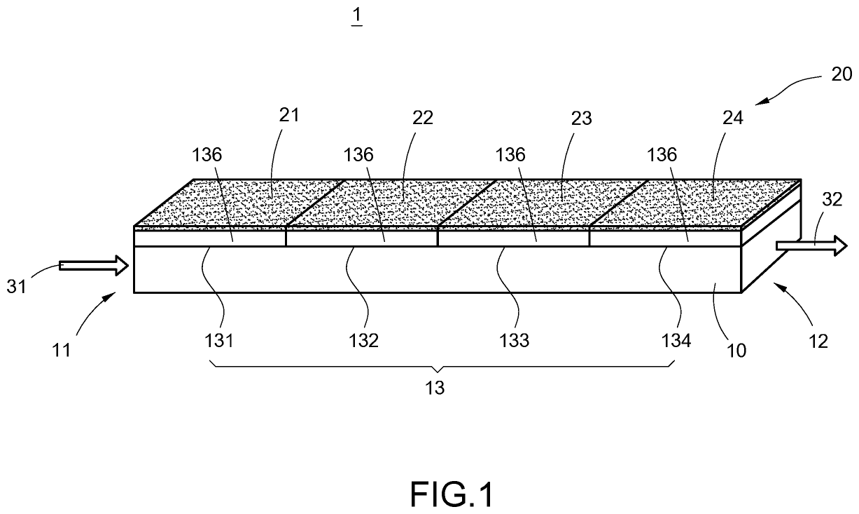

FIG. 1 is an external view of a first embodiment of a sensing device of the present disclosure.

As shown in FIG. 1, a sensing device 1 of the present disclosure includes an optical waveguide substrate 10 and a plurality of biological probes 20.

The optical waveguide substrate 10 includes a light input end 11 and a light output end 12. Further, a biosensing region 13 is formed on one side of the optical waveguide substrate 10 between the light input end 11 and the light output end 12, and the biosensing region 13 is used for placing an analyte (a device under test, DUT), here is not intended to be limiting.

In some embodiments, the sensing device 1 may be applied to protein detection, and may be applied to at least one of surface plasmon resonance (SPR) technology and lossy mode resonance (LMR) technology, here is not intended to be limiting.

In some embodiments, the biosensing region 13 has a first sensing region 131, a second sensing region 132, a third sensing region 133, and a fourth sensing region 134 arranged and aligned along a direction from the light input end 11 to the light output end 12, which are all applied to LMR technology, here is not intended to be limiting.

It is worth mentioning that, the principle of LMR is similar to SPR. When an incident light enters the biosensing region 13 at a critical angle and causes total internal reflection (TIR), the energy of the incident light may generate an evanescent wave on the surface of the biosensing region 13. When effective refractive indices of the biosensing region 13 are matched with the incident light, a coupling between the incident light and the evanescent wave may be observed from a spectrum of a reflected light reflected from the biosensing region 13, and some wavelengths with loss of light intensity may be observed. The wavelength with loss of light intensity is referred to as the “LMR wavelength” and is one of key points of observation when the present disclosure is used. In addition, both the TE wave and the TM wave are resonated with the biosensing region 13 applied with LMR technology, so there is no polarization or filtering is required for the incident light. Comparing with SPR technology, LMR technology has high sensitivity and is easy to be used, here is not intended to be limiting.

In some embodiments, the first sensing region 131, the second sensing region 132, the third sensing region 133, and the fourth sensing region 134 all include a lossy mode resonance (LMR) layer 136, and the plurality of biological probes 20 are formed on the LMR layer 136 by self-assembly after surface modification to the LMR layer 136, here is not intended to be limiting.

In some embodiments, the LMR layer 136 is overlaid on a part of the biosensing region 13, and a metal oxide material with a real part of a dielectric constant being much larger than an imaginary part may be selected, and the lossy mode may be generated. In some embodiments, the LMR layer 136 may be composed of metal oxide materials such as indium tin oxide (ITO), titanium oxide (TiOx), zinc oxide (ZnOx), etc., here is not intended to be limiting.

In some embodiments, a material of the optical waveguide substrate 10 may be one of a glass material, a quartz material, other light-guiding materials, or polymer materials (for example, polyethylene terephthalate (PET), polymethyl methacrylate (PMMA), etc.), or may be made of other materials with low optical energy loss, here is not intended to be limiting. In some embodiments, the LMR layer 136 is coated on the glass substrate as the optical waveguide substrate 10 by RF sputtering, and the description of the RF sputter is omitted here for brevity.

The plurality of biological probes 20 are arranged and aligned on the optical waveguide substrate 10 along the direction from the light input end 11 to the light output end 12, here is not intended to be limiting.

In some embodiments, the analyte corresponding to the plurality of biological probes 20 may include glycated heme (HbA1c) in phosphate buffered saline (PBS), or may also include bovine serum albumin (BSA) solution, etc., here is not intended to be limiting.

In some embodiments, since the LMR layer 136 plated on the optical waveguide substrate 10 may not adsorb HbA1c by itself, the surface modification must be carried out to bond with the boride functional group, so that the boride functional group adsorbs HbA1c, and the LMR wavelength may shift when the boride functional group adsorbs to HbA1c. Finally, an object of detection by spectral observation is achieved, here is not intended to be limiting.

In some embodiments, the surface modification may be performed in the following order. The first step is cleaning, and the LMR layer 136 is sequentially washed with acetone, absolute ethanol, ultrapure water, potassium hydroxide aqueous solution, and ultrapure water. The second step is a hydroxylation treatment, and the LMR layer 136 is washed with an RCA solution (for example, a mixed solution of ammonia water and hydrogen peroxide) to remove organic contaminants and generate hydroxyl groups (OH). The third step is the silanization treatment, the hydroxyl group is attached to the silane and leaves the end with isocyanate to be combined with boric acid. The fourth step is a decarboxylation treatment, the carboxyl group (COOH) is removed to facilitate the bonding of the isocyanate group to the benzene ring, carbon dioxide is generated during the reaction, so that bubble generation may be observed. That is, the surface modification is succussed, here is not intended to be limiting.

Further, the plurality of biological probes 20 respond different resonance wavelengths along the direction corresponding to different analytes.

In some embodiments, especially for the analyte that is mixed with multiple unknown substances, or the resonance wavelengths change over time (for example, biomolecules, etc.), the plurality of biological probes 20 respond multiple resonance wavelengths, it is possible to avoid missing any substance to be tested due to setting a wrong single resonant wavelength, here is not intended to be limiting.

In some embodiments, the plurality of biological probes 20 include first probes 21, second probes 22, third probes 23, and fourth probes 24. The first probes 21 are arranged in the first sensing region 131 adjacent to the light input end 11, the second probes 22 are arranged in the second sensing region 132, the third probes 23 are arranged in the third sensing region 133, and the fourth probes 24 are arranged in the fourth sensing region 134 adjacent to the light output end 12. Further, the resonance wavelength responded by the first probe 21 is different from the resonance wavelength responded by the second probe 22, the resonance wavelength responded by the second probe 22 is different from the resonance wavelength responded by the third probe 23, and the resonance wavelength responded by the third probe 23 is different from the resonance wavelength responded by the fourth probe 24. The plurality of biological probes 20 fabricated on each sensing region may be used as a grabbing mechanism for specific biomolecules, here is not intended to be limiting.

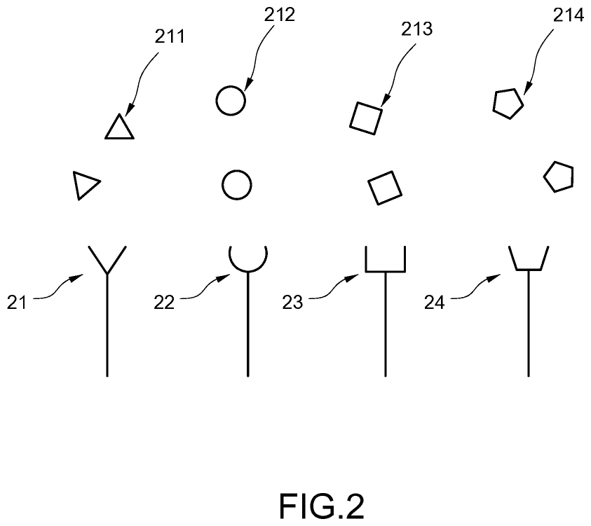

FIG. 2 is a structural diagram of biological probes of the sensing device of the present disclosure.

As shown in FIG. 2, the first probe 21, the second probe 22, the third probe 23 and the fourth probe 24 are corresponding to different protein molecules or chimeric structures with DNA structures, respectively. For example, the first chimera 211, the second chimera 212, the third chimera 213, and the fourth chimera 214 are contained in the same drop of the analyte. When the analyte contacts at least part of the first probe 21, the second probe 22, the third probe 23, and the fourth probe 24 at the same time, the first probe 21 is used to combine with the first chimera 211, the second probe 22 is used to combine with the second chimera 212, the third probe 23 is used to combine with the third chimera 213, and the fourth probe 24 is used to combine with the fourth chimera 214. That is, different probes have specificity for different chimeras without compatibility, here is not intended to be limiting.

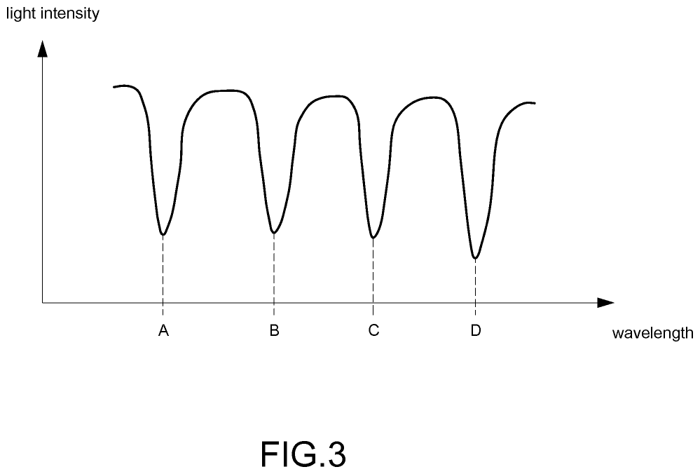

FIG. 3 is a spectrogram view of a signal strength sensed by the sensing device of the present disclosure.

As shown in FIG. 3, if a detection instrument (for example, a spectrometer) is used to detect the spectrum of the reflected light reflected from the biosensing region 13, the detection instrument is configured to observe the loss of light intensity of some wavelengths from the light output end 12 of the optical waveguide substrate 10. As shown in FIG. 3, the positions A, B, C, and D corresponding to different wavelength may be used to determine the possible substances contained in the analyte by different specific wavelengths. Further, position A is corresponding to the detection result of the first sensing region 131, position B is corresponding to the detection result of the second sensing region 132, position C is corresponding to the detection result of the third sensing region 133, position D is corresponding to the detection result of the fourth sensing region 134, here is not intended to be limiting.

Therefore, the sensing device 1 of the present disclosure is structured by arranging and aligning the plurality of biological probes 20 on the optical waveguide substrate 10. Comparing with the related art, expensive and complicated optical equipment such as bulky lens groups and air-cushion optical shockproof equipment are not required in the disclosure. In addition, the optical path set in a form of planar waveguide does not need a complicated light alignment mechanism, and it is easy to achieve miniaturization and mass production.

It is worth mentioning that, in some embodiments, the plurality of biological probes 20 are arranged and aligned along the direction from the light input end 11 to the light output end 12 according to different resonance wavelengths. Therefore, when the plurality of biological probes 20 are corresponding to different analytes simultaneously, the plurality of biological probes 20 respond different resonance wavelengths simultaneously along the direction.

Especially for an analyte that is mixed with multiple unknown substances, or the resonance wavelengths change over time (for example, biomolecules, etc.), the present disclosure may avoid missing any substance to be tested due to setting a wrong single resonant wavelength, so that the analyte is label free and tedious steps in whole experimental process are avoided.

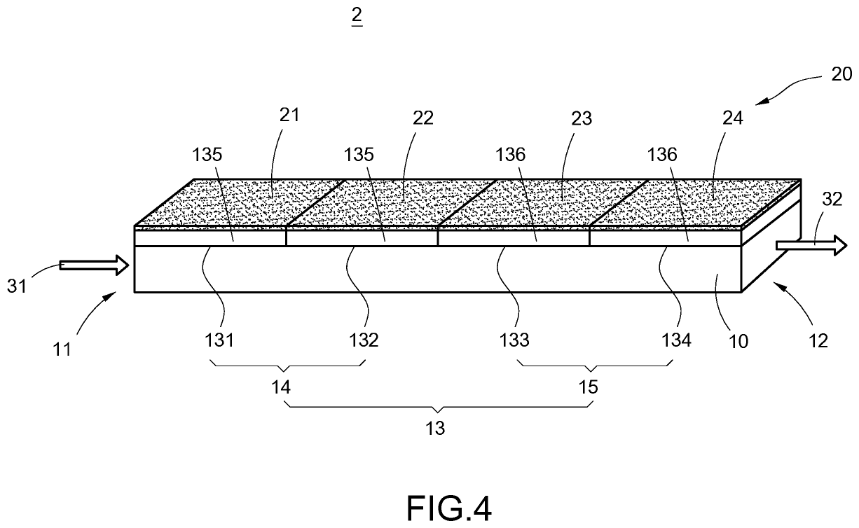

FIG. 4 is an external view of a second embodiment of the sensing device of the present disclosure.

A sensing device 2 of the second embodiment described in the present disclosure is similar to the sensing device 1 of the first embodiment, the difference is that the biosensing region 13 of the optical waveguide substrate 10 is divided into a transverse magnetic (TM) resonance region 14 and a transverse electronic (TE) resonance region 15 free from overlapping with each other. That is, the TM resonance region 14 is not overlapped with the TE resonance region 15.

Further, a TM resonance region 14 is applied to the SPR technology only responding to the TM wave, and a TE resonance region 15 is applied to the LMR technology that is simultaneously responding to the TE wave and the TM wave. At the same time, the TM resonance region 14 may be regarded as a magnetic field filter relative to the TE resonance region 15, finally a detection accuracy of the spectrum may be higher, here is not intended to be limiting.

In some embodiments, the TM resonance region 14 is adjacent to the light input end 11, and covers the first sensing region 131 and the second sensing region 132. The TE resonance region 15 is adjacent to the light output end 12 and covers the third sensing region 133 and the fourth sensing region 134. Comparing with the aforementioned first embodiment, the LMR layer 136 of the second embodiment only covers the third sensing region 133 and the fourth sensing region 134, and does not cover the first sensing region 131 and the second sensing region 132, here is not intended to be limiting.

In some embodiments, the first probe 21 is arranged in the first sensing region 131 of the TM resonance region 14 and adjacent to the light input end 11. The second probe 22 is arranged in the second sensing region 132 of the TM resonance region 14 and adjacent to the TE resonance region 15. The third probe 23 is arranged in the third sensing region 133 of the TE resonance region 15 and adjacent to the TM resonance region 14. The fourth probe 24 is arranged in the fourth sensing region 134 of the TE resonance region 15 and adjacent to the light output end 12, here is not intended to be limiting.

In some embodiments, the TM resonance region 14 includes a surface plasmon resonance (SPR) layer 135, and the first probe 21 and the second probe 22 are formed on the SPR 135 by self-assembly after surface modification of the SPR layer 135, here is not intended to be limiting.

In some embodiments, the steps for surface modification of the SPR layer 135 may be the same as the aforementioned steps for surface modification of the LMR layer 136, here is not intended to be limiting.

In some embodiments, the SPR layer 135 is coated with a metal material on the glass substrate as the optical waveguide substrate 10 by RF sputtering, and the description of the RF sputter is omitted here for brevity.

Therefore, the optical waveguide substrate 10 is divided into the TM resonance region 14 and the TE resonance region 15 free from overlapping with each other. At the same time, the TM resonance region 14 may be regarded as a magnetic field filter relative to the TE resonance region 15, which improves the detection accuracy of the spectrum in detection, here is not intended to be limiting.

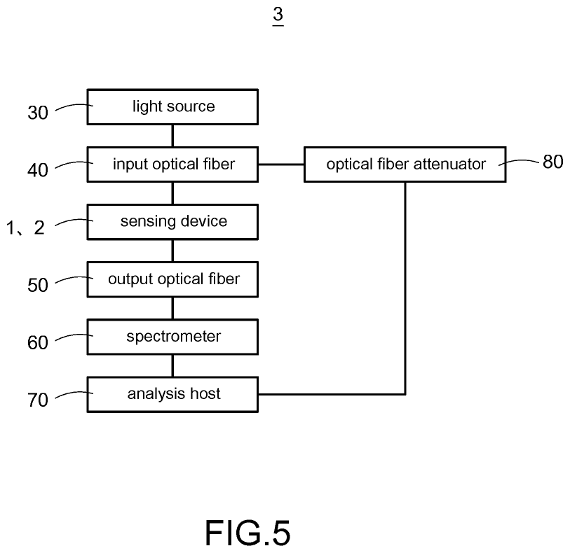

FIG. 5 is a schematic diagram of a configuration of a biosensing system of the present disclosure.

Please refer to FIG. 1, FIG. 4 and FIG. 5. Based on the sensing devices 1 and 2 described above, comparing to the sensing device 1 of the first embodiment and the sensing device 2 of the second embodiment, the biosensing system 3 of the present disclosure further include a light source 30, an input optical fiber 40, an output optical fiber 50, a spectrometer 60, and an analysis host 70.

The light source 30 may be a halogen lamp that outputs a first light 31 with a broad spectrum, here is not intended to be limiting.

The input optical fiber 40 is coupled to the light source 30 for transmitting the first light 31 output by the light source 30, here is not intended to be limiting.

The sensing devices 1 and 2 are coupled to the input optical fiber 40, so that the first light 31 output by the light source 30 enters the light input end 11 of the optical waveguide substrate 10, here is not intended to be limiting.

The output optical fiber 50 is coupled to the light output end 12 of the optical waveguide substrate 10 for receiving a second light 32 output from the optical waveguide substrate 10. Further, when the sensing device 2 described in the second embodiment is used, the second light 32 includes the reflected light from the TM resonance region 14 and the TE resonance region 15 at the same time, so that the spectrometer 60 detects SPR and LMR at the same time, here is not intended to be limiting.

The spectrometer 60 is coupled to the output optical fiber 50, and used to receive the second light 32 that is outputted from the optical waveguide substrate 10. The spectrometer 60 simultaneously detects the first sensing region 131, the second sensing region 132, the third sensing region 133, and the fourth sensing region 134 on the sensing devices 1 and 2 that respond different resonant wavelengths, here is not intended to be limiting.

The analysis host 70 is coupled to the spectrometer 60 for analyzing the second light 32 received by the spectrometer 60, here is not intended to be limiting.

In some embodiments, a fixture (not shown in figures) is provided between the input optical fiber 40 and the output optical fiber 50, and the fixture is used to fix the sensing devices 1 and 2 to form a measurement platform. Further, the fixture is equipped with adjustable slide rails to match the sensing devices 1 and 2 with different sizes, so that the fixture makes the measurement application flexible, here is not intended to be limiting.

In some embodiments, an optical fiber attenuator 80, that is electrically connected to the analysis host 70, may be added to the input optical fiber 40. The optical fiber attenuator 80 may be used to manually adjust the light intensity attenuation of the input fiber 40 to fine-tune the first light 31 input to the sensing devices 1 and 2 to improve the detection result of the spectrometer 60, here is not intended to be limiting.

Therefore, the sensing devices 1 and 2 may be further combined with the light source 30, the input optical fiber 40, the output optical fiber 50, the spectrometer 60, and the analysis host 70 into a system that may be operated independently.

It is worth mentioning that, using optical fiber as the light input and output conduction medium avoids the complicated light alignment mechanism in related technology, and saves the volume and weight. In addition, in combination with the sensing devices 1 and 2 of the present disclosure for multiplex detection of multiple resonance wavelengths, only a single light source 30 and a single spectrometer 60 are needed to perform sensing of multiple analytes, so that the purposes of the multiple analytes may be sensed with label free are achieved, here is not intended to be limiting.

Therefore, the sensing device of the present disclosure is completed by arranging and aligning the plurality of biological probes on the optical waveguide substrate. Comparing with the related art, expensive and complicated optical equipment such as bulky lens groups and air-cushion optical shockproof equipment are not required in the disclosure. In addition, the optical path set in a form of planar waveguide does not need a complicated light alignment mechanism, and it is easy to achieve miniaturization and mass production.

It is worth mentioning that, the plurality of biological probes are arranged and aligned along the direction from the light input end to the light output end according to different responding resonance wavelengths. Therefore, when the plurality of biological probes are corresponding to different analytes simultaneously, the plurality of biological probes respond different resonance wavelengths simultaneously along the direction. Especially for an analyte that is mixed with multiple unknown substances, or the resonance wavelengths change over time (for example, biomolecules, etc.), the present disclosure may avoid missing any substance to be tested due to setting a wrong single resonant wavelength, so that the analyte is label free and tedious steps in whole experimental process are avoided.

In some embodiments, the optical waveguide substrate is divided into the TM resonance region and the TE resonance region free from overlapping with each other. At this time, the TM resonance region may be regarded as a magnetic field filter relative to the TE resonance region, which improves the detection accuracy of the spectrum in detection, here is not intended to be limiting.

It is worth mentioning that, the sensing devices may further combine with the light source, the input optical fiber, the output optical fiber, the spectrometer, and the analysis host into a system that may operate independently. Using optical fiber as the light input and output conduction medium avoids the complex light alignment mechanism in related technology, and saves the volume and weight. In addition, in combination with the sensing devices of the present disclosure for multiplex detection of multiple resonance wavelengths, only a single light source and a single spectrometer are needed to perform sensing of multiple analytes, so that the purposes of the multiple analytes may be sensed with label free are achieved, here is not intended to be limiting.

Therefore, the biosensing system and the sensing device of the present disclosure avoid using a prism with a huge volume, and perform multiplex detection on multiple resonance wavelengths. Therefore, the technical problems in the related art of miniaturization and reducing the difficulty of detection being difficult to be realized are solved, and the purposes of convenient carrying, easy mass-production and convenient detection are achieved.

The above is only a detailed description and drawings of the preferred embodiments of the present disclosure, but the features of the present disclosure are not limited thereto, and are not intended to limit the present disclosure. All the scope of the present disclosure shall be subject to the scope of the following claims. The embodiments of the spirit of the present disclosure and its similar variations are intended to be included in the scope of the present disclosure. Any variation or modification that may be easily conceived by those skilled in the art in the field of the present disclosure may be covered by the following claims.

What is claimed is:

1. A sensing device comprising:
an optical waveguide substrate, comprising a light input end and a light output end; and
a plurality of biological probes, arranged and aligned on the optical waveguide substrate along a direction from the light input end to the light output end;
wherein, the plurality of biological probes are configured to respond different resonance wavelengths along the direction corresponding to different analytes.

2. The sensing device of claim 1, wherein, the optical waveguide substrate comprises a transverse magnetic (TM) resonance region and a transverse electric (TE) resonance region free from overlapping with each other, the TM resonance region is adjacent to the light input end, and the TE resonance region is adjacent to the light output end.

3. The sensing device of claim 2, wherein, the plurality of biological probes comprises:
a first probe, arranged in the TM resonance region and adjacent to the light input end; and
a second probe, arranged in the TM resonance region and adjacent to the TE resonance region;
wherein, a resonance wavelength responded by the first probe is different from a resonance wavelength responded by the second probe.

4. The sensing device of claim 3, wherein, the TM resonance region comprises a surface plasmon resonance (SPR) layer, and the first probe and the second probe are arranged on the SPR layer.

5. The sensing device of claim 2, wherein, the plurality of biological probes comprise:
a third probe, arranged in the TE resonance region and adjacent to the TM resonance region; and
a fourth probe, arranged in the TE resonance region and adjacent to the light output end;
wherein, a resonance wavelength responded by the third probe is different from a resonance wavelength responded by the fourth probe.

6. The sensing device according to claim 5, wherein, the TE resonance region comprises a lossy mode resonance (LMR) layer, and the third probe and the fourth probe are arranged on the LMR layer.

7. The sensing device of claim 1, wherein, a material of the optical waveguide substrate is one of a glass material, a quartz material or a polymer material.

8. A biosensing system, comprising:
a light source, configured to output a first light;
a sensing device as claimed in claim 1, the sensing device configured to receive the first light and output a second light; and
a spectrometer, connected to the sensing device and configured to receive the second light.

9. The biosensing system of claim 8, wherein, the spectrometer is configured to simultaneously detect a plurality of sensing regions on the sensing device responding to different resonance wavelengths.

10. The biosensing system of claim 8, wherein, the light source comprises a halogen lamp.

11. A biosensing system, comprising:
a light source, configured to output a first light;
a sensing device as claimed in claim 2, the sensing device configured to receive the first light and output a second light; and
a spectrometer, connected to the sensing device and configured to receive the second light.

12. The biosensing system of claim 11, wherein, the spectrometer is configured to simultaneously detect a plurality of sensing regions on the sensing device responding to different resonance wavelengths.

13. The biosensing system of claim 11, wherein, the light source comprises a halogen lamp.

14. A biosensing system, comprising:
a light source, configured to output a first light;
a sensing device as claimed in claim 3, the sensing device configured to receive the first light and output a second light; and
a spectrometer, connected to the sensing device and configured to receive the second light.

15. The biosensing system of claim 14, wherein, the spectrometer is configured to simultaneously detect a plurality of sensing regions on the sensing device responding to different resonance wavelengths.

16. The biosensing system of claim 14, wherein, the light source comprises a halogen lamp.

17. A biosensing system, comprising:
a light source, configured to output a first light;
a sensing device as claimed in claim 5, the sensing device configured to receive the first light and output a second light; and
a spectrometer, connected to the sensing device and configured to receive the second light.

18. The biosensing system of claim 17, wherein, the spectrometer is configured to simultaneously detect a plurality of sensing regions on the sensing device responding to different resonance wavelengths.

19. The biosensing system of claim 17, wherein, the light source comprises a halogen lamp.
